(19) United States
(12) Patent Application Publication
(10) Pub. No.: US 2013/0110729 A1
(43) Pub. Date: May 2, 2013

(54) System, Device and Method for Secure Handling of Key Credential Information Within Network Servers

(71) Applicant: James A. Mcalear, Ottawa (CA)

(72) Inventor: James A. Mcalear, Ottawa (CA)

(21) Appl. No.: 13/704,624

(22) PCT Filed: Jun. 17, 2011
(86) PCT No.: PCT/CA11/00714

§ 371 Date: Dec. 18, 2012

(30) Foreign Application Priority Data
Jun. 18, 2010 (CA) 2,707,996

(51) Int. Cl. G06Q 20/38

(52) U.S. Cl. CPC G06Q 20/3821
USPC 705/76

(57) ABSTRACT

A method comprising, providing a server accessing a network through a network interface card, the network interface card receiving a message from a remote client, the message comprising credentials for performing a request, in response to the network interface card receiving the message, the network interface card preventing the credentials from being provided to the server and checking the credentials against those previously stored in a directly attached memory; and the network interface card indicating to the server the outcome of attempting to perform the request, wherein the credentials remain inaccessible to the server during the method.

### FIELD OF THE INVENTION

The present invention relates to computer networking and more particularly to the secure means of handling key credential information within servers, when the server may not be trusted due to the presence of malware.

### BACKGROUND OF THE INVENTION

Commerce over the Internet has become very popular. Such commerce takes many forms, from purchasing merchandise from online vendors to conducting online banking and stock trading. Common to all such transactions is the need to confirm private, secure information. Typically the transactions are carried out is using secure encrypted connections. However, there are still opportunities to capture the private information that is used during online transactions, for example to obtain passwords, Personal Identification Numbers (PIN), social security numbers driver's license numbers and account numbers, to name a few. Illegal procurement of such information and using the same in a fraudulent manner is commonly referred to as identity theft.

While the Internet is by far the largest and most pervasive computer network, the problem of identity theft occurs in other networks as well. For example, identity theft can occur entirely within the confines of a corporate network or a university network wherein a dishonest individual employs stolen PINs enabling access to confidential information.

In the context of preventing malware access to critical credentials, it is desirable to provide credentials handling that keeps the use of critical credentials outside of the purview of server resident malware.

It is also desirable to provide for secure and independent transaction accounting at the server end that cannot be altered by malware.

### SUMMARY OF THE INVENTION

Accordingly, one object of the present invention is to provide a system that protects critical credentials from resident malware at the server end of the connection.

Another object of the invention is to provide for secure and independent transaction accounting at server ends of these transactions.

According to one aspect of the invention, there is provided a method comprising: providing a server accessing a network through a network interface card; the network interface card receiving a message from a remote client, the message comprising credentials for performing a request; in response to the network interface card receiving the message, the network interface card preventing the credentials from being provided to the server and checking the credentials against those previously stored in a directly attached memory; and the network interface card indicating to the server the outcome of attempting to perform the request, wherein the credentials remain inaccessible to the server during the method.

As described hereinafter, a system, method and device for secure use of key credentials at the server end of the connection is provided. The system, method and device utilizes secure logic circuitry placed with the network interface card of the server which can handle submitted credential messages from PC users. Attached to this circuitry is a credentials storage unit that has all the authorized user credentials for the services provided by the server. In operation, when the server requires a user to provide credentials for a selected transaction, the server will issue an “authorization required” message to the user via the network interface card and the network. The user will then send a network message back that offers the requested credentials. In accordance with this invention, the logic circuitry of the server network interface card will note this message, and not pass it along to the server CPU, where it could be accessed by resident malware. Instead, the credentials will be checked against those held in the associated memory, and if the credentials successfully match, the logic circuitry will post an “authorized” message to the CPU; otherwise the circuitry will post a “denied” message to the CPU. In this way, any server resident malware cannot see the actual credentials messages.

As described, while this invention will prevent any malware from access to the content of the critical credentials, the malware could still have access to any authorized content that is meant to be protected for the user. By denying the malware access to a password that a user may also employ on another site—this limits the reach of potential identity theft. Analogously, by applying the same is principles to transactions that utilize credit cards and other payment mechanisms malware is prevented from obtaining critically important financial credentials. With the arrangement above, the network interface card of the server would intercept any user supplied credit card or payment credentials, and block these details from being sent to the server motherboard and within the possible purview of malware. Instead, the circuitry in the network interface card would initiate the credit card or other payment mechanism with the authorized financial institution (e.g. Visa or MasterCard or representative bank), and upon completion of the transaction, the network interface card would report a message as to the status of the transaction (approved or denied with any confirmation number) to the main part of the server. With this arrangement, malware never has any access to any credit card numbers or other payment information. Upon completion of the transaction, the network interface card can store a record of the transaction within an attached memory unit for secure accounting purposes.

### BRIEF DESCRIPTION OF THE DIAGRAMS

A preferred embodiment of the present invention is described below with reference to the accompanying drawings, in which:

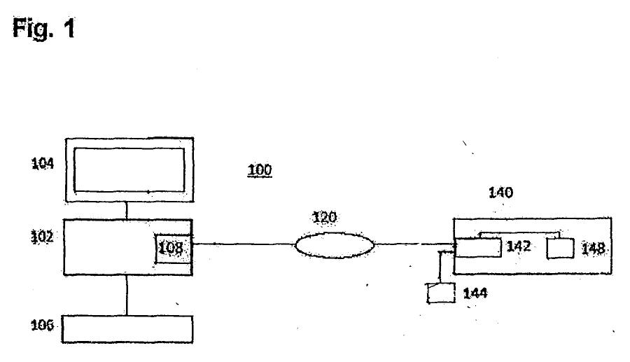

FIG. 1 is the simplified block diagram of a system for secure and convenient provision and tracking of key credentials transactions;

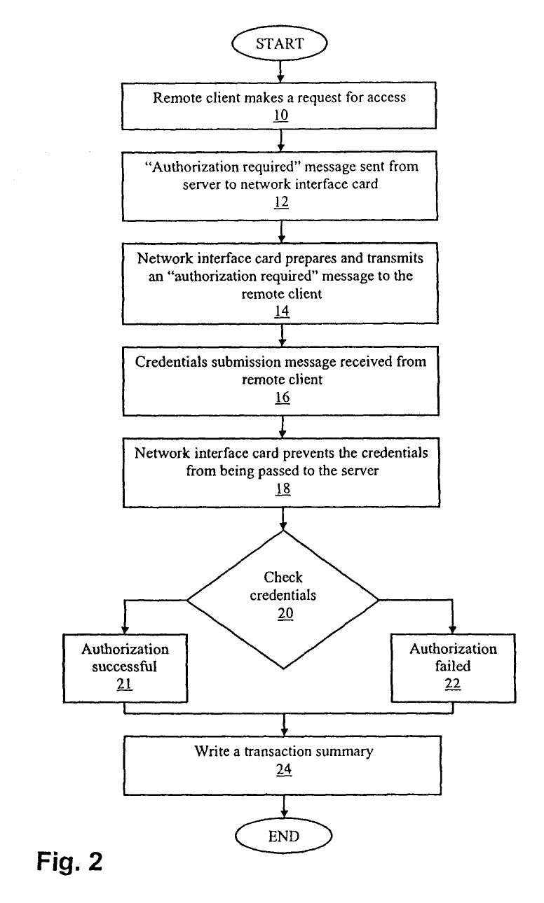

FIG. 2 is a simplified flow diagram of a method for secure handling of key credentials according to a preferred embodiment of the invention;

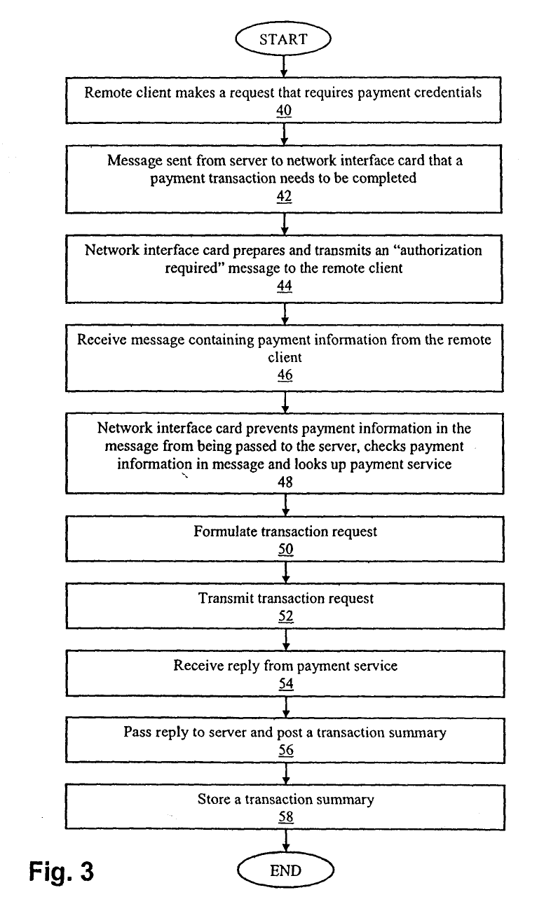

FIG. 3 is a simplified flow diagram of a method for secure handling of key financial credentials according to a preferred embodiment of the invention.

### DESCRIPTION OF THE PREFERRED EMBODIMENT

Unless defined otherwise, all technical and scientific terms used herein have the same meaning as commonly understood by one of ordinary skill in the art to which the invention belongs.

Although any methods and materials similar or equivalent to those described herein can be used in the practice or testing of the present invention, the preferred methods and materials are now described.

While the description of the preferred embodiment herein below is with reference to an Internet connection for sake of simplicity, it will become evident to those skilled in the art that the embodiments of the invention are not limited thereto, but are also applicable for use with various other networks such as, for example, corporate networks or university networks.

Referring to FIG. 1, as described hereinafter, a system, method and device for secure use of key credentials at the server end of the connection is provided.

The system, method and device utilizes secure logic circuitry placed with the network interface card of the server which can handle submitted credential messages from a user's Personal Computer (PC) 100 or workstation main computing unit 102 that is connected via a communications network 120 to a remote Internet server 140. Typically computers and servers connect to networks via network interface cards 108 and 142 respectively. The user typically interacts with the computer via the keyboard 106 and the display 104.

Hackers can infiltrate servers to grab credentials from many users over time.

The present invention provides a solution to this problem in the following manner. Rather than store and handle user credentials in memory to which the server's CPU 148 has access, credentials are stored and handled by the network interface card 142 with an associated credentials memory unit 144 that is physically and electronically inaccessible to the server's CPU (that is, the network interface card 142 provides no such connection) and out of the purview of any resident malware.

In operation, when the server 140 sends out an “authentication required” message, and the personal computer 102 replies with a message containing credentials from a user, circuitry in the network interface card 142 connected to the server 140 blocks this credentials message from being passed to the server's CPU 148. Instead the supplied credentials are compared with the credentials previously stored in the credentials memory unit 144 to see if the user can be authenticated. If the credentials successfully match credentials in the credentials memory unit 144, then an “authorization success” message is posted to the CPU 148 of the server 140 so that the server 140 knows that the user has been successfully authenticated. Additionally, any session identifying information such as the user IP address and port number (and possible proxy channel identifier or other unique session indicator such as a HTTP “Cookie” field) can be provided to the CPU 148 of the server 140. If the supplied credentials do not match credentials in the credentials memory unit 144, then an “authorization failed” message is supplied to the CPU 148 of the server 140 along with the session identification information. The credentials memory unit 144 may also log the details of each of these transactions within memory.

As a particular example, during conventional web browsing, when a user attempts to access content that first requires the presentation of required credentials, the server 140 sends out a “HTTP 401 Authorization Required” message with an embedded realm title such as “Web Mail Login” to alert the user to exactly which set of credentials needs to be supplied. At the remote to client 100, the browser client would then offer a login screen for Web Mail Login, with fields for the user to type in a User ID and Password that would then be assembled and sent to the server 140 in a defined Authorization message. These messages can be further contained in an encrypted session over the internet, typically by the SSL protocol.

In operation, when the server requires a user to provide credentials for a selected transaction, the server will issue an “authorization required” message to the user via the network interface card and the network. The user will then send a network message back that offers the requested credentials. In accordance with this invention, the logic circuitry of the server network interface card will note this message, and not pass it along to the server CPU, where it could be accessed by resident malware. Instead, the credentials will be checked against those held in the associated memory, and if the credentials successfully match, the logic circuitry will post an “authorized” message to the CPU; otherwise the circuitry will post a “denied” message to the CPU. In this way, any server resident malware cannot see the actual credentials messages.

In one embodiment of the present invention, the credentials memory unit 144 connected to the network interface card 142 and used to store credentials could be a conventional, and removable, non-volatile memory card, such as a common USB memory stick or an SD card or one of its many variants. In this embodiment, with the credentials memory unit 144 being removable, credentials records could be saved to the credentials memory unit 144 on a stand-alone computer that is inaccessible to any hacker. Once all of the desired credentials have been saved to the credentials memory unit 144 using the stand-alone computer, the credentials memory unit 144 could be connected to the network interface card 142 for use.

Additionally, if the credential memory unit 144 is removable, a stand-alone computer could also be used for accounting purposes by reading out the stored transaction records.

Conventional credentials stored within the credentials memory unit 144 could be organized by three-tuples of “Realm”, “User ID” and “Password”. In this embodiment of the present invention, the Realm field would be used to distinguish various services that could be offered on a service, such as “Web Mail”, “Chat Room” or “Instant Messaging”. When a user supplies a three-tuple of credentials, the credentials memory unit 144 will be searched, and if a perfect match is found, an authorized message is posted to the server CPU 148, along with the realm and the user ID, along with relevant session identification information to allow the user to access his authorized content. This embodiment is preferred if the credentials exchange uses SSL-which would also be implemented by the circuitry of the enhanced network interface card 142. If no such encryption is employed, then a preferred embodiment would employ the hashing of credentials as described by the HTTP Digest Access Authentication extension to the HTTP protocol—with corresponding changes to the fields stored within the credentials storage unit and how the “Authorization Required” message is composed and how the corresponding reply is validated.

In one embodiment, the credentials memory unit 144 attached to the network interface 142 can be used to store transaction logs of the activities that is unalterable by malware. This provides some independent means to spot inconsistencies that may arise from the activity of malware, without the malware being able to cover its tracks.

Referring to FIG. 2, a flowchart of a method for authenticating a user using the network interface card 142 and the credentials memory unit 144 is shown. At step 10, the method begins when a remote client 100 requests access to content of the server 140 that requires presentation of valid user credentials before access is granted. In response to the request, the server 140 sends a message to the network interface card 142 that an “authorization required” message is to be sent to the remote client 102 at step 12. The server 140 typically provides the network interface card 142 with the client IP address, port numbers, the “realm” of access and any needed proxy or session information. This information is then used by the network interface card 142 to prepare and transmit an “authorization required” message to the remote client 102 at step 14.

In response to the “authorization required” message sent at step 14, the server 140 should receive a credential submission message from the remote client 102 at step 16. Typically, when the remote client 100 received the “authorization required” message, the remote client 100 provides a login screen on the display 104 with fields for the user to type in a User ID and Password. This User ID and Password can then be assembled into the credential submission message which the network interface card 142 receives at step 16. These messages can be transmitted from the remote client 100 to the server 140 in an encrypted session over the network 120.

After the credential submission message is received at step 16, the method can move onto step 18 with the network interface card 142 preventing the credential submission message from reaching the CPU 148 of the server 140. The network interface card 142 can intercept the credential submission message and check the credentials received in the credential submission message against the credentials stored in the credentials memory unit 144 at step 20. If the credentials submitted by the remote client 100 match one of the credentials stored in the credentials memory unit 144, the method can move onto step 21 and the network interface card 142 indicates to the CPU 148 of the server 140 that the credentials submitted match credentials in the credentials memory unit 144. This can be done by transmitting an “authorization success” message to the CPU 148 of the server 140, along with the user ID and the relevant session identification.

However, if at step 20 it is determined that the credentials submitted by the remote client 102 does not match one of the credentials stored in the credentials memory unit 144, the method can move onto step 22 and the interface network card 142 can indicate to the server 140 that the authorization failed. This can be done by posting an authorization failed message along with the relevant session details.

Optionally, the method can move to step 24 with the network interface card 142 writing a transaction summary into the credential memory unit 144. In this manner, a separate and independent record of transaction summaries can be stored in the credential memory unit 144 allowing these transaction records to be checked against the transaction summaries collected by the server 140 to see if malware is tampering with the transaction records.

The method illustrated in FIG. 2 can be used to authenticate a user and allow the user access to content on the server 140. In some cases, it might also be useful to use the network interface card 142 and the credential memory unit 144 to handle payment transactions over the network 120. For handling of credit card and payment transactions, extra functionality can be provided.

The credentials memory unit 144 can have stored thereon the merchant account numbers and network locations for the various credit card and payment companies that the server operator is willing to accept. Then upon the receipt of an accepted credit card or payment type, the circuitry of the network interface card 142 could then contact the selected card company to complete the transaction independently of the CPU 148 of the server 140 and therefore would remain beyond the ability of any malware to interfere with these critical transactions. The malware would also be unable to alter any logs of such activity to interfere with proper accounting and reconciliation processes that are critical to sound business operations.

FIG. 3 illustrates a flowchart of a method for using the network interface card 142 and the credentials memory unit 144 to conduct a transaction. The method begins at step 40 whereby a remote client requests an action from the server 140 that requires valid payment credentials. The desired pay mechanism (e.g. Visa, MasterCard, Amex, etc.) can already have been chosen by a user of the remote client 100 before step 40 is performed. At step 42 the server 140 can send a message to the network interface card 142 that a payment transaction needs to be completed.

Typically, this message will include the client session information, the payment amount and the chosen payment ID. The server 140 typically provides the network interface card 142 with the client IP address, port numbers, the “realm” of access and any needed proxy or session information. This information is then used by the network interface card 142 to prepare and transmit a message for the remote client 100 at step 44.

At step 46, the network information card 142 receives a response from the remote client 100. When the remote client 100 receives the message from the server 140 at step 44, the remote client 100 will have the user provide the required information. Typically, a user will be prompted to provide the information in labeled fields. It should be noted here that the HTTP protocol doesn't have a specific set of messages for supplying payment credentials—typically a HTML web form submission is used within an SSL session to supply the credentials. For this protocol, there can be an advantage to utilizing the same HTTP 401 message and reply as noted above. Thus a HTTP 401 message could provide a realm message like “Visa/Purchase of $48.52-Enter: Card Number-and-Expiry Date & Verification Number” and then the user could enter the credit card number in the User ID field, and the expiry date and supplementary three digit verification number in the password field, and have these protected in this manner. It is also preferred that such transactions are also protected by having the logic circuitry provide SSL encryption to the transmitted and received content. (In this example it is presumed that the cardholder name can be supplied in a conventional HTML web form, as the name is not normally considered as protection-worthy credentials.) Optimally, all the necessary fields could be properly and individually labeled for a user to confidently supply the needed information. Someone skilled in the art could employ the possible “auth-param” extension fields allowed within HTTP 401 messages to set-up the right fields and labels for a user to supply the needed credential aspects (and back down to User ID and Password for implementations that are non-compliant with such extensions).

The information gathered from the user by the remote client 100 is used to assemble a message containing the required payment credentials and this message can be transmitted to the server 140. Receipt of this message containing the payment information is step 46 of the method.

After the message containing the payment credentials is received at step 46, the method can move onto step 48 with the network interface card 142 preventing the payment credentials in the message from reaching the CPU 148 of the server 140. At step 48 the network interface card 142 can intercept the message, parse the payment credentials contained in the message and look up the network address for a payment service (such as a bank or credit card company). The network interface card 142 can then formulate a conventional transaction request at step 50 using the merchant account number (also accessed in the credentials memory unit 144) along with the client supplied payment credentials and transmit this transaction request over the network 120 to the payment service at step 52. In this manner, the payment information is only made available to the network interface card 142. The CPU 148 of the server 140 never gains access to the payment information. If the server 140 is infected with malware, the payment information is never at risk of being obtained by the malware.

The network interface card 142 will receive a reply from the payment service at step 54. This reply will typically include whether the requested transaction was approved or denied, a transaction identifier and possibly a reason if the transaction was denied (e.g. NSF). At step 56, the network interface card 142 will pass this reply to the CPU 148 of the server 140 and the server 140 will record a transaction summary. Optionally, at step 58, the network interface 142 can also store a transaction summary within the credential memory unit 144.

As described, while this invention will prevent any malware from access to the content of the critical credentials, the malware could still have access to any authorized content that is meant to be protected for the user. By denying the malware access to a password that a user may also employ on another site—this limits the reach of potential identity theft. Analogously, the same principle applies to transactions that utilize credit cards and other payment mechanisms. With the arrangement above, the network interface card of the server would intercept any user supplied credit card or payment credentials, and block these details from being sent to the server motherboard and within the possible purview of malware. Instead, the circuitry in the network interface card would initiate the credit card or other payment mechanism with the authorized financial institution (e.g. Visa or MasterCard or representative bank), and upon completion of the transaction, the network interface card would report a message as to the status of the transaction (approved or denied with any confirmation number) to the main part of the server. With this arrangement, malware never has any access to any credit card numbers or other payment information.

The present invention has been described herein with regard to preferred embodiments. However, it will be obvious to persons skilled in the art that a number of variations and modifications can be made without departing from the scope of the inventions as described herein.

What is claimed is:

1. A method for secure handling by a server of credential information for performing a transaction wherein the credential information is received through a network interface of the server from a remote client over a communications network, the method comprising:
a) before passage of the received credential information to the processor of the server, detecting the received credential information;
b) after detecting the received credential information, preventing any passage of the credential information to the processor of the server;
c) comparing the credential information to previously stored credentials information of a credentials memory and determining an authorization outcome from the comparing; and,
d) supplying to the processor of the server the authorization outcome.

2. The method of claim 1 whereby remote client identification information and information identifying the transaction are detected with the credential information and the supplying includes supplying the remote client identification information and information identifying the transaction to the processor of the server.

3. The method of claim 1 or 2 whereby the transaction is a payment transaction, the credential information comprises payment information and the credentials memory comprises previously stored payment services information, the method further comprising: i) performing the transaction with a payment service of the previously stored payment services information using the payment information of the received credential information; and, ii) supplying to the processor of the server a payment reply.

4. The method of claim 2 wherein the transaction comprises one or more of a group comprising a request for access, an initial credentials set-up and a payment transaction.

5. The method of any of claims 1 to 3 further comprising providing to the credentials memory for storage a log of payment information for the performed transaction.

6. The method of claim 5 whereby the payment information includes a purchase amount for the performed transaction.

7. The method of any of preceding claims 1 to 6 whereby the received credential information is encrypting and the method further comprising decrypting the received credential information.

8. A system for use with a server for secure handling of credential information for performing a transaction wherein the credential information is received through a network interface of the server from a remote client over a communications network, the system comprising:
(a) secure handling circuitry connected to the network interface and configured for: I) communicating with a credentials memory; II) before passage of the received credential information to the processor of the server, detecting the received credential information; III) after detecting the received credential information, preventing any passage of the credential information to a processor of the server; IV) comparing the credential information to previously stored credentials information of a credentials memory; V) determining an authorization outcome from the comparing; and, VI) supplying to the processor of the server the authorization outcome; and,
(b) credentials memory connected to the secure handling circuitry and comprising the previously stored credentials information.

9. The system of claim 8 wherein the transaction is a payment transaction, the credential information comprises payment information and the credentials memory comprises previously stored payment services information, the secure handling circuitry further configured for performing the transaction with a payment service of the previously stored payment services information using the payment information of the received credential information; and, ii) supplying to the processor of the server a payment reply.

10. The system of claim 8 or 9 whereby the transaction comprises one or more of a group comprising a request for access, an initial credentials set-up and a payment transaction.

11. The system of any of claims 8 to 10 whereby the secure handling circuitry is further configured for providing to the credentials memory for storage a log of payment information for the performed transaction.

12. The system of claim 11 whereby the payment information includes a purchase amount for the performed transaction.

13. The system of any of claims 8 to 12 whereby the credentials memory is removable from the secure logic circuitry.

14. The system of any of claims 8 to 13 whereby the credential information is encrypted and the secure handling circuitry is further configured for decrypting the credential information.
